(19) United States
(12) Patent Application Publication
(10) Pub. No.: US 2014/0093203 A1
(43) Pub. Date: Apr. 3, 2014

(54) Single-Fiber Bi-Directional Optical Transceiver

(71) Applicants: Hong-Yuan CHEN, Chengdu (CN); Yifan HSIEH, Chengdu (CN)

(72) Inventors: Hong-Yuan CHEN, Chengdu (CN); Yifan HSIEH, Chengdu (CN)

(21) Appl. No.: 13/717,436

(22) Filed: Dec. 17, 2012

(30) Foreign Application Priority Data
Sep. 29, 2012 (CN) 201210370712.3

(51) Int. Cl. G02B 6/43

(52) U.S. Cl. CPC G02B 6/43
USPC 385/33; 29/592.1

(57) ABSTRACT

A single-fiber bi-directional optical transceiver includes a laser diode, a photodiode, a splitter, a band filter between the splitter and the photodiode, a fiber optic connector, a first coupling lens between the laser diode and the splitter, a second coupling lens between the splitter and the fiber optic connector, and a shield plate having a run-through hole therein. The laser diode, the first coupling lens, the splitter, the second coupling lens and the fiber optic connector are coaxial and/or in series, and the photodiode, the band filter and the reflection path of the splitter are coaxial and/or in series. The shield plate is configured to stop wide-angle reflected light from being absorbed by the photodiode, while narrow-angle reflected light is isolated by the band filter. Thus, the single-fiber bi-directional optical transceiver can effectively reduce, avoid or eliminate crosstalk.

### CROSS REFERENCE TO RELATED APPLICATION

This application claims the benefit of Chinese Patent Application No. 201210370712.3, filed on Sep. 29, 2012, which is incorporated herein by reference as if fully set forth herein.

### FIELD OF THE INVENTION

The present invention generally relates to the field of optical communications and devices therefor. More specifically, embodiments of the present invention pertain to a single-fiber bi-directional optical transceiver, particularly circuits, devices, and method(s) of making and/or using the same.

### DISCUSSION OF THE BACKGROUND

A single-fiber bi-directional optical transceiver is an optical transmitter and receiver (TR) module capable of converting electrical signals into optical signals and optical signals into electrical signals. FIG. 1 illustrates the structure of a conventional single-fiber bi-directional optical transceiver 100, including a. laser diode 104, a photodiode 101, a band filter 103, a splitter 106, and an optical fiber connector 108 containing an optical fiber 109. A second coupling lens 107 is placed between the photodiode 101 and the optical fiber 109, while a first coupling lens 105 is placed between the laser diode 104 and the optical fiber 109. The laser diode 104, the splitter 106, the first coupling lens 105 and the optical fiber 109 are coaxial in series. The band filter 103 is placed between the splitter 106 and the photodiode 101. Also, the photodiode 101, the band filter 103 and the reflection path of the splitter 106 are coaxial in series. Generally, when a small package, such as a compact small form-factor pluggable (CSFP) package is required in a telecommunication and/or data communication application, the second coupling lens 107 is generally moved to a position between the splitter 106 and the optical fiber 109 (see FIG. 2), thereby reducing the distance of the photodiode 101 from the splitter 106.

Referring to FIG. 2, part of the luminous energy from the laser diode 104 may be reflected when the light strikes the coupling lens 107 and/or the end face of the optical fiber 109, and then the reflected light is further reflected from the splitter 106 to the band filter 103. The isolation of the band filter 103 is relatively low when the light has a relatively high incidence angle, such as in the case of light that is initially reflected from the coupling lens 107 and/or the end face of the optical fiber 109. Thus, light having a relatively high incidence angle can easily go through the band filter 103 and be absorbed by the photodiode 101, increasing crosstalk and thereby affecting the capability of the single-fiber bi-directional optical transceiver 100 or 110 to convert optical signals into electrical signals.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY OF THE INVENTION

Embodiments of the present invention relate to a single-fiber bi-directional optical transceiver that provides a solution for absorption of reflected light having a wide angle of reflection by a photodiode and that prevents excessive crosstalk. The present single-fiber bi-directional optical transceiver can effectively (i) prevent and/or minimize absorption of reflected light having a wide angle of reflection and (ii) eliminate and/or reduce crosstalk.

The present invention provides a single-fiber bi-directional optical transceiver, comprising a laser diode, a photodiode, a band filter, a splitter and a fiber optic connector. A second coupling lens is positioned between the splitter and the fiber optic connector, while a first coupling lens is positioned between the laser diode and the splitter. The laser diode, the first coupling lens, the splitter, the second coupling lens, and the fiber optic connector are coaxial and/or in series. The band filter is between the splitter and the photodiode. Also, the photodiode, the band filter, and the reflection path of the splitter are coaxial and/or in series. Furthermore, a shield plate having a run-through hole is between the band filter and the photodiode.

In various embodiments of the present invention, the splitter is positioned at an angle of 45° relative to the optical path, and the run-through hole is in the center of the shield plate.

In further embodiments of the present invention, the first coupling lens is a non-spherical lens, and the second coupling lens is a spherical lens.

The present invention further provides a single-fiber bi-directional optical transceiver, comprising a laser diode, a photodiode, a band filter, a splitter, and a fiber optic connector. A first coupling lens is between the laser diode and the splitter. The laser diode, the first coupling lens, the splitter, the second coupling lens, and the fiber optic connector are coaxial and/or in series. The band filter is between the splitter and the photodiode, while a second coupling lens is between the band filter and the photodiode. Also, the photodiode, the second coupling lens, the band filter and the reflection path of the splitter may be coaxial and/or in series. Furthermore, a shield plate having a run-through hole is between the splitter and the photodiode (e.g., the band filter and the photodiode).

In another embodiment of the present invention, the splitter is positioned at an angle of 45° relative to the optical path, and the run-through hole is in the center of the shield plate. Typically, the first coupling lens is a non-spherical lens, and the second one is a spherical lens.

Relative to existing technologies, the present invention includes a shield plate having a run-through hole being placed between the band filter and the photodiode in the single-fiber bi-directional optical transceiver. Advantageously, light with a relatively high incidence angle is blocked by the shield plate after going through the band filter. Thus, reflected light cannot be absorbed by the photodiode. Light having a small incidence angle can go through the run-through hole in the center of the shield plate. However, the isolation of the band filter is relatively high when the light has a relatively small incidence angle, such that light having a small incidence angle is isolated by the band filter, thereby effectively reducing and/or avoiding crosstalk.

The present invention overcomes disadvantages of the existing technology (e.g., absorption of reflected light having a wide angle of reflection by a photodiode and excessive crosstalk). Thus, advantages of the present single-fiber bi-directional optical transceiver include effectively preventing and/or minimizing absorption of reflected light having a wide angle of reflection by the photodiode and eliminating and/or reducing crosstalk.

These and other advantages of the present invention will become readily apparent from the detailed description of various embodiments below.

### BRIEF DESCRIPTION OF THE DRAWINGS

FIG. 1 is a structure diagram showing a conventional single-fiber bi-directional optical transceiver.

FIG. 2 is another structure diagram showing a conventional single-fiber bi-directional optical transceiver.

FIG. 3 is a diagram showing the light path of the single-fiber bi-directional optical transceiver of FIG. 2.

FIG. 4 is a diagram showing the relationship between the isolation of the band filter and the angle of incidence.

FIG. 5 is a structure diagram showing an exemplary embodiment of the single-fiber bi-directional optical transceiver of the present invention.

FIG. 6 is a diagram showing the light path of the single-fiber bi-directional optical transceiver of FIG. 5.

FIG. 7 is a structure diagram showing another exemplary embodiment of the single-fiber bi-directional optical transceiver of the present invention.

### DETAILED DESCRIPTION

Reference will now be made in detail to various embodiments of the invention, examples of which are illustrated in the accompanying drawing(s). In order to achieve the objectives, technical solutions and advantages of the present invention more clearly, further details of the invention are described below with regard to the Figure(s). While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention as defined by the appended claims. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures, components, and circuits have not been described in detail so as not to unnecessarily obscure aspects of the present invention. The embodiments described here are only used to explain, rather than limit, the invention.

Thus, the technical proposal(s) of embodiments of the present invention will be fully and clearly described in conjunction with the drawings in the following embodiments. It will be understood that the descriptions are not intended to limit the invention to these embodiments. Based on the described embodiments of the present invention, other embodiments can be obtained by one skilled in the art without creative contribution and are in the scope of legal protection given to the present invention.

Furthermore, all characteristics, measures or processes disclosed in this document, except characteristics and/or processes that are mutually exclusive, can be combined in any manner and in any combination possible. Any characteristic disclosed in the present specification, claims, Abstract and Figures can be replaced by other equivalent characteristics or characteristics with similar objectives, purposes and/or functions, unless specified otherwise. Each characteristic is generally only an embodiment of the invention disclosed herein.

For the sake of convenience and simplicity, the terms “connected to,” “coupled with,” “coupled to,” and “in communication with” (which terms also refer to direct and/or indirect relationships between the connected, coupled and/or communicating elements, unless the context of the term's use unambiguously indicates otherwise) are generally used interchangeably herein, but are generally given their art-recognized meanings.

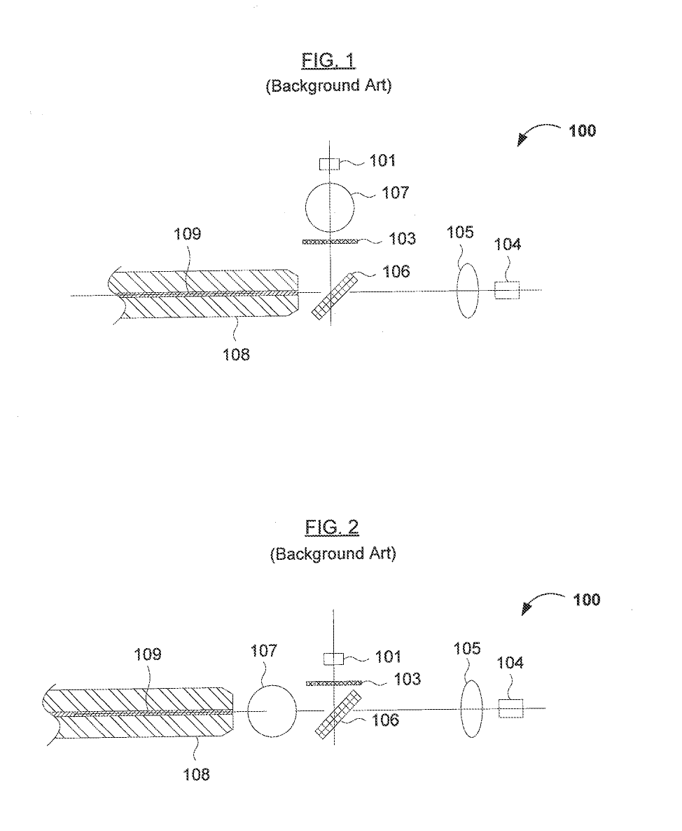

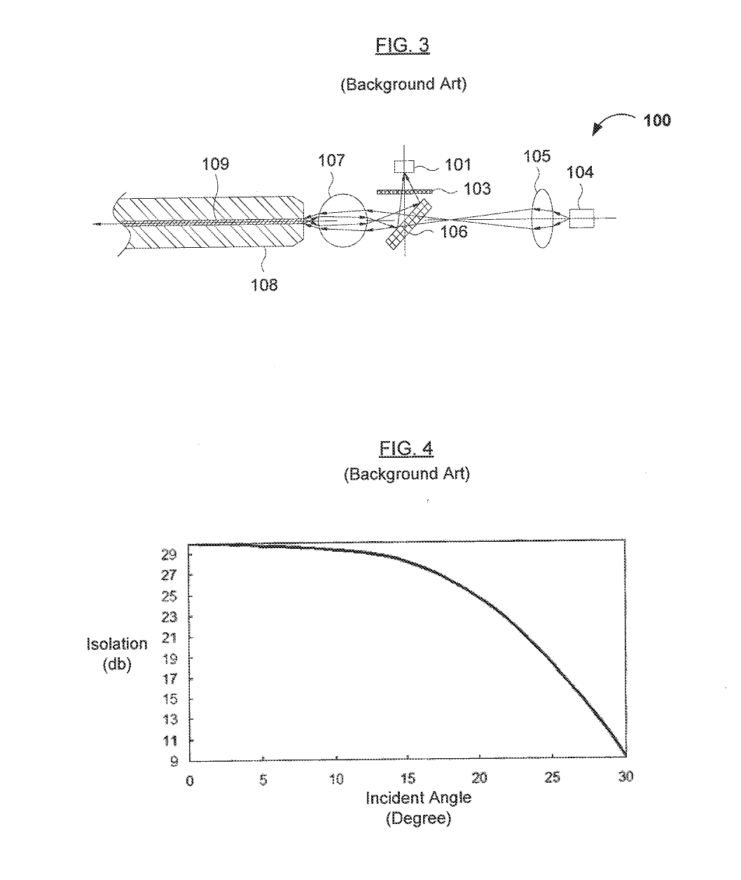

Referring back to FIGS. 1-3, the majority of the luminous energy comes from the laser diode 104 which is transmitted via the optical fiber 109, while part of the luminous energy is reflected from the optical fiber 109 end face to the second coupling lens 107. Next, the luminous energy is projected from the second coupling lens 107 to the splitter 106, and further reflected from the splitter 106 to the band filter 103.

As shown in FIG. 3, the isolation of the band filter 103 is relatively low when the light has a relatively high incidence angle. Thus, light having a high incidence angle can easily go through the band filter 103 and be absorbed by the photodiode 101, increasing crosstalk, thereby affecting the capability of the single-fiber bi-directional optical transceiver 100 in converting optical signals into electrical signals.

Referring to FIG. 4, the relationship between the isolation of the band filter 103 (FIG. 1) and the angle of incident light is shown. When light has a relatively small angle of incidence, the isolation of the band filter 103 is relatively great. On the contrary, when light has a relatively high angle of incidence, the isolation of the band filter 103 is relatively low, resulting in greater crosstalk.

### Embodiment 1

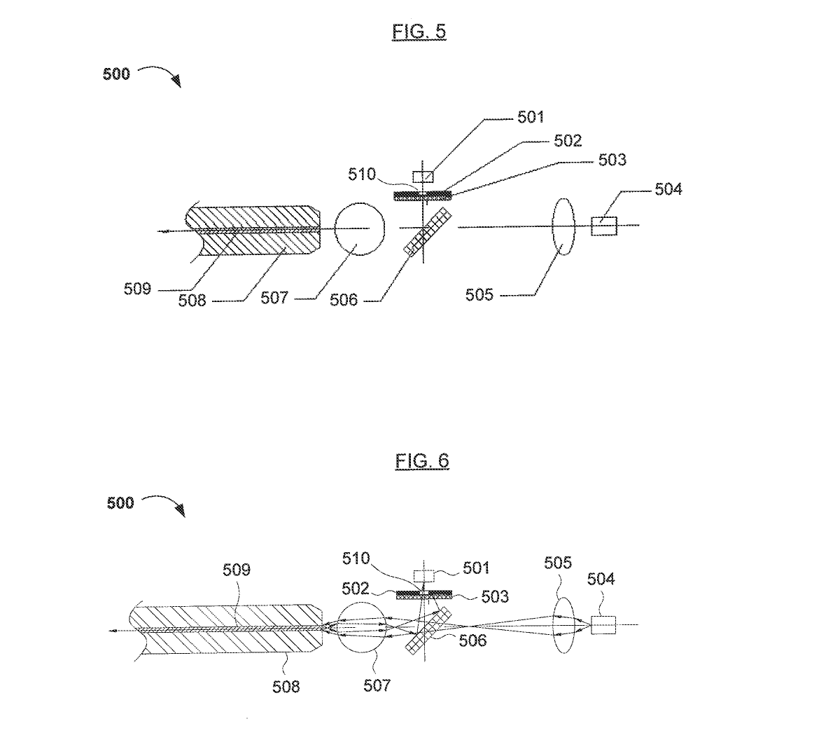

Referring to FIG. 5, a first exemplary embodiment of a single-fiber bi-directional optical transceiver 500 of the present invention is shown. The single-fiber bi-directional optical transceiver 500, comprising a laser diode 504, a photodiode 501, a band filter 503 having a shield plate 502 thereon, a splitter 506, a fiber optic connector 508, and an optical fiber 509. Splitter 506 is position at an angle of 45° relative to the optical path. A first coupling lens 505 is placed between laser diode 504 and splitter 506, and a second coupling lens 507 is placed between the splitter 506 and an optical fiber connector 508. In various embodiments of the present invention, the first coupling lens 505 is a non-spherical lens, and the second coupling lens 507 is a spherical lens.

In further embodiments of the present invention, the laser diode 504, the first coupling lens 505, the splitter 506, the second coupling lens 507, and the optic fiber connector 508 are coaxial and/or in series. The band filter 503 is placed between the splitter 506 and the photodiode 501. Furthermore, the band filter 503 and the reflection path of the splitter 506 are coaxial and/or in series.

In an exemplary embodiment of the present invention, the shield plate 502 has a run-through hole 510 in the center of the shield plate 502. The shield plate 502 may be placed between the band filter 506 and the photodiode 501. In this embodiment, the shield plate 502 is on the band filter 503, but in general, the shield plate 502 may have peripheral dimensions in a layout view that is coextensive or substantially coextensive with the peripheral dimensions of the shield plate 502.

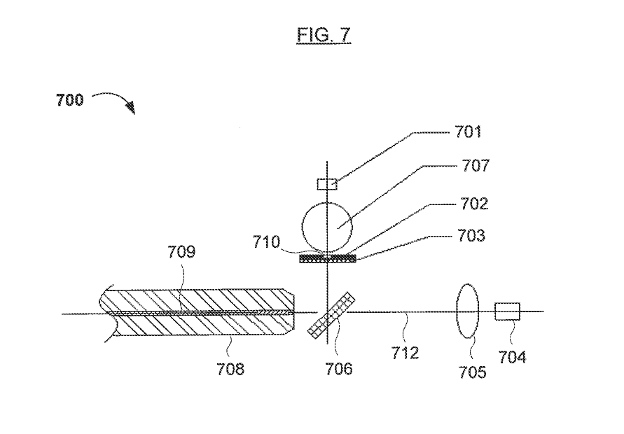

Referring to FIG. 6, the light path of the single-fiber bi-directional optical transceiver 500 is shown. The optical fiber connector 508 has an optical fiber 509 inside. Most of the luminous energy from the laser diode 504 is transmitted to other receivers (e.g., in a network) via the optical fiber 509. However, part of the luminous energy may be reflected from the end face of the optical fiber 509 back to the second coupling lens 507, then projected from the second coupling lens 507 to the splitter 506, and further reflected from the splitter 506 to the band filter 503. Also, a part of the luminous energy reflected from the second coupling lens 507 is further reflected from the splitter 506 to the band filter 503.

Since the shield plate 502 has a run-through hole 510, light with a relatively high incidence angle is blocked by the shield plate 502 after going through the band filter 503. Thus, the reflected light is not absorbed by the photodiode 501. However, light having a small incidence angle can go through the run-through hole 510 in the center of the shield plate 502. In various embodiments, the run-through hole 510 has dimensions (e.g., a diameter or area) that allow 75% or more (e.g., 80%, 90%, 95%, 99% or any other minimum value greater than or equal to 75%) of light or luminous energy having an incidence angle of 15° or less (e.g., ≦10°, ≦5°, or any other minimum value≦15°) to pass through, the remaining light or luminous energy being effectively blocked by the shield plate 502. In general, the incidence angle may be defined. herein as the angle of reflection of light from the splitter 506.

Thus, the isolation of the band filter 503 that applies to light having a small incidence angle is relatively high, such that light having a small incidence angle is isolated by the band filter 503. Therefore, the present single-fiber bi-directional optical transceiver 500, can effectively reduce and even avoid crosstalk, and improve the capability of the single-fiber bi-directional optical transceiver 500 to convert optical signals into electrical signals.

### Embodiment 2

Referring to FIG. 7, a second exemplary embodiment of a single-fiber bi-directional optical transceiver 700 of the present invention is shown. The single-fiber bi-directional optical transceiver 700 comprises a laser diode 704, a photodiode 701, a band filter 703 having a shield plate 702 thereon, a splitter 706, a fiber optic connector 708, and an optical fiber 709. The components in FIG. 7 that have the same last digit as similar or corresponding components in FIG. 5 may be the same as or similar to those components in FIG. 5. Splitter 706 is at an angle of 45° relative to the optical path 712. A first coupling lens 705 is positioned between the laser diode 704 and the splitter 706, and a second coupling lens 707 is positioned between the band filter 703 and the photodiode 701.

Thus, the structure of the single-fiber bi-directional optical transceiver 700 in the second embodiment (i.e., Embodiment 2) is substantially similar to the structure of the single-fiber bi-directional optical transceiver 500 in the first embodiment (i.e., Embodiment 1), except that the second coupling lens 707 is between the band filter 703 and the photodiode 701. Alternatively, the second coupling lens 707 can be between the splitter 706 and the filter 703. The first coupling lens 705 may be a non-spherical lens, and the second coupling lens 707 may be a spherical lens.

In various embodiments of the present invention, the laser diode 704, the first coupling lens 705, the splitter 706, and the optical fiber connector 708 are coaxial and/or in series. As shown in FIG. 7, the band filter 703 is between the splitter 706 and the second coupling lens 707. Thus, the band filter 703, the second coupling lens 707, and the reflection path of the splitter 706 are also coaxial and/or in series.

In an exemplary embodiment of the present invention, the shield plate 702 has a run-through hole 710 in the center of the shield plate 702, similar to or the same as the run-through hole 510 in the shield plate 502 of FIG. 5. The shield plate 702 may be placed or formed directly on the upper surface of the band filter 703, between the band filter 703 and the second coupling lens 707. Alternatively, the shield plate 702 may be positioned or formed on the surface of the band filter 703 facing away from photodiode 701, or elsewhere between the band filter 703 and the photodiode 701.

### CONCLUSION/SUMMARY

Thus, the present invention provides a single-fiber bi-directional optical transceiver and method(s) of making and/or using the same. The single-fiber bi-directional optical transceiver comprises a laser diode, a photodiode, a band filter, a splitter and a fiber optic connector. A first coupling lens is between the laser diode and the splitter. The laser diode, the first coupling lens, the splitter, the second coupling lens and the fiber optic connector are coaxial and/or in series. The band filter is between the splitter and the photodiode, while a second coupling lens is between the band filter and the photodiode. Also, the photodiode, the second coupling lens, the band filter and the reflection path of the splitter are coaxial and/or in series. Furthermore, a shield plate having a run-through hole is between the splitter and the photodiode (e.g., between the band filter and the photodiode).

Thus, the single-fiber bi-directional optical transceiver of the present invention advantageously and/or effectively prevents and/or minimizes absorption of reflected light having a wide angle of incidence by the photodiode, and reduces and/or eliminates crosstalk.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching(s). The embodiments were chosen and described in order to best explain the principles of the invention and its practical application(s), to thereby enable others skilled in the art to best utilize the invention and various embodiments with various modifications as are suited to the particular use contemplated. It is intended that the scope of the invention be defined by the claims appended hereto and their equivalents.

What is claimed is:

1. A single-fiber bi-directional optical transceiver, comprising:
a photodiode;
a splitter below the photodiode;
a band filter between the photodiode and the splitter;
a shield plate between the photodiode and the splitter, the shield plate having a run-through hole therein;
a laser diode;
a first coupling lens adjacent to the laser diode, between the laser diode and the splitter;
a fiber optic connector having an optical fiber therein; and
a second coupling lens between (i) the splitter and the fiber optic connector or (ii) the hand filter and the photodiode.

2. The transceiver of claim 1, wherein the second coupling lens is between the splitter and the fiber optic connector, and the laser diode, the first coupling lens, the splitter, the second coupling lens and the fiber optic connector are coaxial and/or in series.

3. The transceiver of claim 2, wherein the laser diode, the first coupling lens, the splitter, the second coupling lens and the fiber optic connector are coaxial and in series.

4. The transceiver of claim 1, wherein the second coupling lens is between the splitter and the fiber optic connector, and the photodiode, the band filter and a reflection path of the splitter are coaxial and/or in series.

5. The transceiver of claim 4, wherein the photodiode, the band filter and the reflection path of the splitter are coaxial and in series.

6. The transceiver of claim 1, wherein the splitter is at an angle of 45° relative to an optical path between the laser diode and the fiber optic connector.

7. The transceiver of claim 1, wherein the run-through hole is in a center of the shield plate.

8. The transceiver of claim 7, wherein the run-through hole has dimensions that allow 75% or more of light or luminous energy having an incidence angle of 15° or less to pass through the shield plate, the remaining light or luminous energy being effectively blocked by the shield plate.

9. The transceiver of claim 1, wherein the first coupling lens is a non-spherical lens, and the second coupling lens is a spherical lens.

10. The transceiver of claim 1, wherein the second coupling lens is between the band filter and the photodiode, and the laser diode, the first coupling lens, the splitter, and the fiber optic connector are coaxial and/or in series.

11. The transceiver of claim 10, wherein the laser diode, the first coupling lens, the splitter, and the fiber optic connector are coaxial and in series.

12. The transceiver of claim 1, wherein the second coupling lens is between the band filter and the photodiode, and the photodiode, the second coupling lens, the band filter and a reflection path of the splitter are coaxial and/or in series.

13. The transceiver of claim 12, wherein the photodiode, the second coupling lens, the band filter and the reflection path of the splitter are coaxial and/or in series.

14. The transceiver of claim 1, wherein the shield plate is on the band filter.

15. A method of forming a single-fiber bi-directional optical transceiver, comprising:
placing a photodiode on a receiver assembly mounting surface;
placing a splitter in a position beneath the photodiode;
forming a shield plate on or adjacent to the band filter, the shield plate having a run-through hole therein;
placing a band filter in a position between the photodiode and the splitter;
placing a laser diode on a transmitter assembly mounting surface;
placing a first coupling lens in a position between the laser diode and the splitter; and
placing a second coupling lens in a first optical path between the photodiode and a fiber optic connector in or on the single-fiber bi-directional optical transceiver.

16. The method of claim 15, wherein the second coupling lens is between (i) the splitter and the fiber optic connection, or (ii) the band filter and the photodiode.

17. The method of claim 16, wherein the second coupling lens is between the splitter and the fiber optic connector, and the laser diode, the first coupling lens, the splitter, the second coupling lens and the fiber optic connector are coaxial and in series, and the photodiode, the band filter and the reflection path of the splitter are coaxial and in series.

18. The method of claim 16, wherein the second coupling lens is between the band filter and the photodiode, and the laser diode, the first coupling lens, the splitter, and the fiber optic connector are coaxial and in series, and the photodiode, the band filter, the second coupling lens, and the reflection path of the splitter are coaxial and in series.

19. The method of claim 15, wherein the splitter is placed at an angle of 45° relative to a second optical path between the laser diode and the fiber optic connector.

20. The method of claim 15, wherein the run-through hole is in a center of the shield plate, and the run-through hole has dimensions that allow 75% or more of light or luminous energy having an incidence angle of 15° or less to pass through the shield plate, the remaining light or luminous energy being effectively blocked by the shield plate.
